(19) United States
(12) Patent Application Publication
(10) Pub. No.: US 2011/0040055 A1
(43) Pub. Date: Feb. 17, 2011

(54) ELECTROCHROMIC CONJUGATED POLYMERS

(75) Inventors: Chun-Guey WU, Hualien County (TW); Ming-Hsuan HO, Taoyuan County (TW); Pei-Fang TSAI, Taitung County (TW)

Correspondence Address: BRIAN M. MCINNIS, 12th Floor, Ruttonjee House, 11 Duddell Street, Hong Kong, HK

(73) Assignee: NATIONAL CENTRAL UNIVERSITY, TAOYUAN COUNTY (TW)

(21) Appl. No.: 12/617,726

(22) Filed: Nov. 13, 2009

(30) Foreign Application Priority Data
Aug. 13, 2009 (TW) 98127270
Oct. 28, 2009 (TW) 98136536

(51) Int. Cl. C08F 228/06

(52) U.S. Cl. 526/257; 526/256

(57) ABSTRACT

A series of conjugated polymers with electrochromic properties and photovoltaic activity are provided. The representative structure formula of the conjugated polymers is shown as structure formula (I):

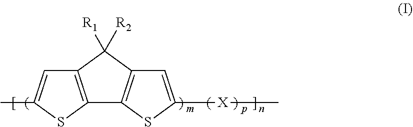

Wherein m can be 1-4, p can be 0-3, and n can be 3-10000; R₁ and R₂ can be —H, —CₐH₂ₐ₊₁, —OCₐH₂ₐ₊₁, —SCₐH₂ₐ₊₁, —N(CₐH₂ₐ₊₁)₂ or —[O(CₐH₂ₐ)₂]_{b} (a=1-15, b=1-5), respectively; and X is an unsaturated moiety.

### CROSS-REFERENCE TO RELATED APPLICATION

This application claims the priority benefit of Taiwan application serial no. 98127270, filed Aug. 13, 2009, the full disclosure of which is incorporated herein by reference.

### BACKGROUND

1. Technical Field

The disclosure relates to a conjugated polymer. More particularly, the disclosure relates to a conjugated polymer having electrochromic property.

2. Description of Related Art

Energy saving, carbon reduction and renewable energy exploitation are important works for sustainable development of the earth. An electrochromic device made by an electrochromic material is one of the energy-saving technologies. However, since the material and technology are still limited, the related product has not been commercialized so far. However, it is believed that economical benefit of a product will not be the only standard for the merit of a product, due to the increasing demand of sustainable development and the progress of science and technology. Therefore, continuing to exploit better electrochromic materials is an important work.

Due to the advantages of high response rate, high optical contrast, high coloring efficiency, easy structure modification and convenient process, conjugated polymers attract great attention from the researchers who work on the electrochromic material. Moreover, the energy gap of a conjugated polymer can be easily adjusted by modifying the conjugated polymer structure to present various colors. For example, various functional groups can be added to the main chain or the side chain of the conjugated polymer to change the energy gap through steric effect or electronic effect. Moreover, the color of the conjugated polymer can also be controlled by modifying the main chain structure, such as forming a copolymer with other monomer unit. Nevertheless, searching for conjugated polymers possessing the properties of easy manufacture, high coloring efficiency, high stability, fast response rate, as well as showing red, green, and blue three primary colors is still an ongoing effort for the scientists.

Furthermore, it is known that conjugated polymers are P-type semiconductors. A polymer solar cell can be made by mixing conjugated polymers with N-type semiconductors, such as C₆₀ or C₇₀. Since various wavelengths of the electromagnetic wave (from infrared to visible ranges) can be absorbed by a conjugated polymer, a good photo-to-electron conversion efficiency can be obtained for the polymer solar cell when conjugated polymer was used as one of the active components.

### SUMMARY

In view of the foregoing, the present invention provides a conjugated polymer that has good electrochromic performance. Since the conjugated polymer can be dissolved in an organic solvent, a thin film of the conjugated polymer can be easily fabricated by spin-coating the organic solution of the conjugated polymer on a substrate. Moreover, conjugated polymer can present red, green, blue, or black colors by proper structural design as well as has high coloring efficiency and high electrochemical stability.

Accordingly, the chemical formula of the conjugated polymer is shown below in a structure formula (1):

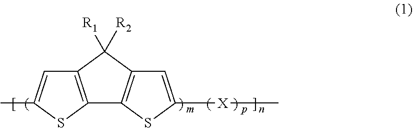

Wherein m is 1-4, p is 0-3, and n is 3-10000;

R₁ and R₂ is —H, —CₐH₂ₐ₊₁, —OCₐH₂ₐ₊₁, —SCₐH₂ₐ₊₁, —N(CₐH₂ₐ₊₁)₂ or —[O(CₐH₂ₐ)₂]_{b}, respectively, wherein a is 1-15, and b is 1-5; and

X is an unsaturated moiety, the chemical structure of the X is one of the following structure formula (2)-(27) as shown below:

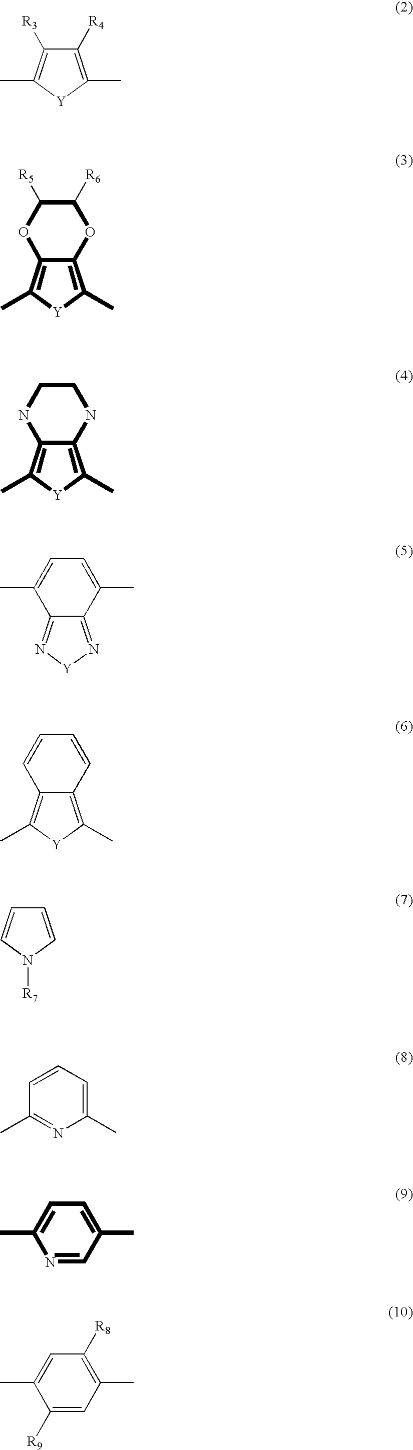

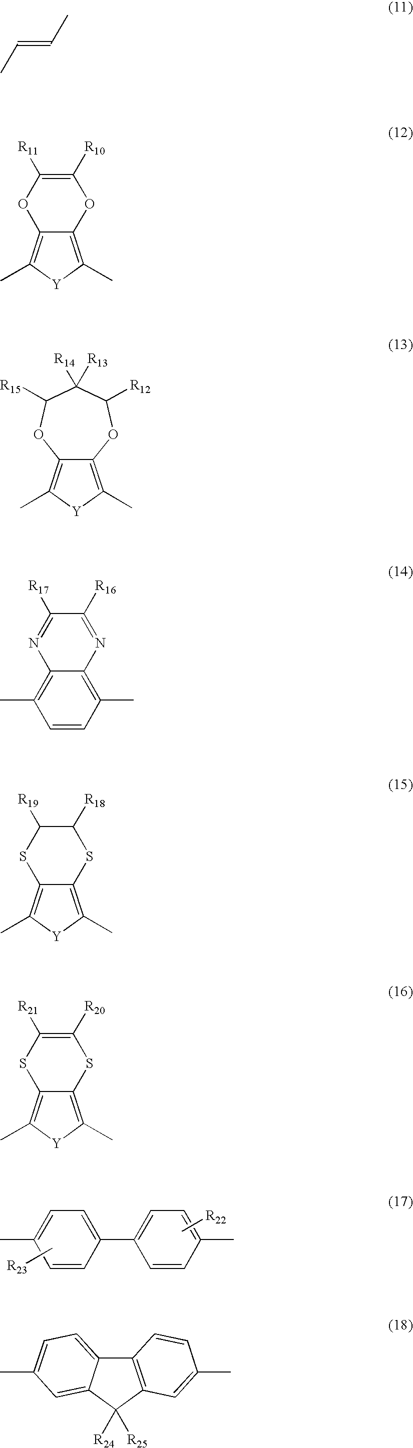

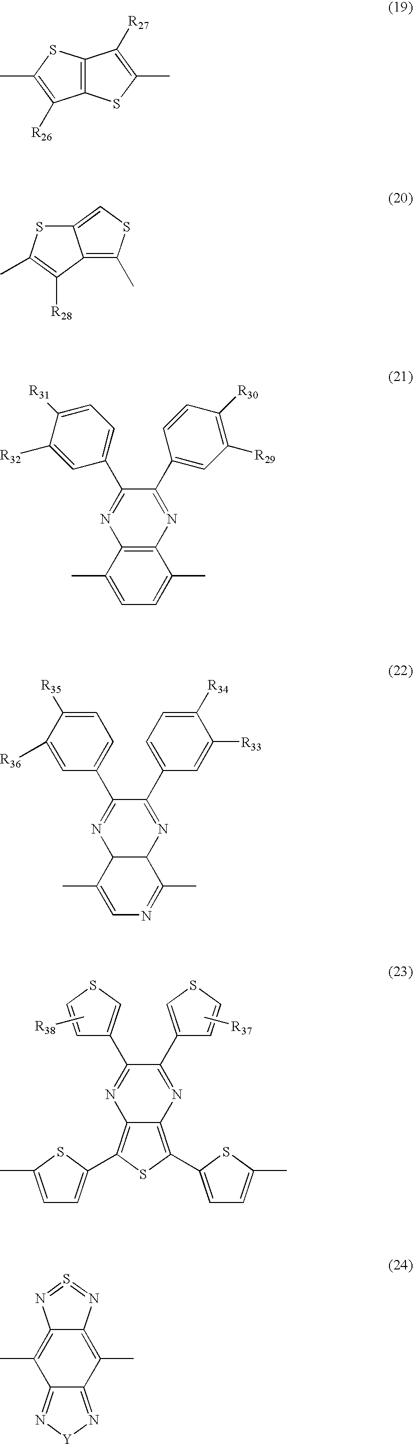

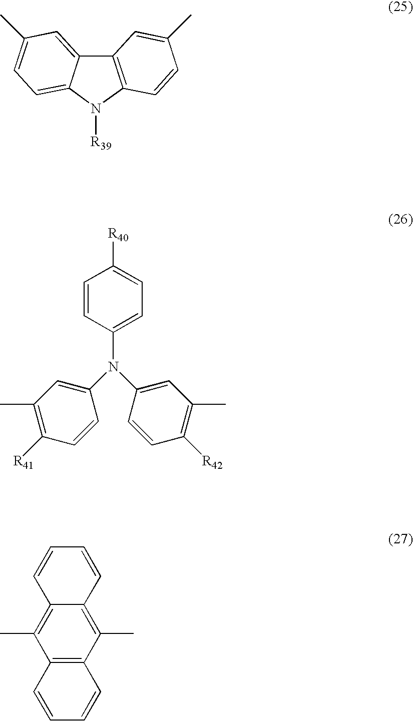

Wherein Y is O, S, or Se; and

R₃-R₄₂ is —H, —C_{c}H_{2c+1}, —OC_{c}H_{2c+1}, —SC_{c}H_{2c+1}, —N(C_{c}H_{2c+1})₂ or —[O(C_{c}H_{2c})₂]_{d}, respectively, wherein c is 1-15, and d is 1-5.

The conjugated polymer has the advantages of:
1. Good manufacture property and high electrochemical stability.
2. Being capable of presenting red, green, blue, or black colors.
3. Having better coloring efficiency.
4. Having lower color switching potential.
5. Being applied to the electrochromic device and used as a photovoltatic material for polymer solar cells.

It is to be understood that both the foregoing general description and the following detailed description are by examples, and are intended to provide further explanation of the invention as claimed.

### BRIEF DESCRIPTION OF THE DRAWINGS

FIG. 1 is a transmittance variation diagram of the maximum absorption peak of PDOCPDT-DOT film upon fast potential switching. The experiment was carried out by using a three-electrode system, including a working electrode made by polymer films on ITO, to undergo 1000 times of redox switching.

### DETAILED DESCRIPTION

### Embodiment 1

In this embodiment, the synthesized conjugated polymer was shown in structure formula (28) below:

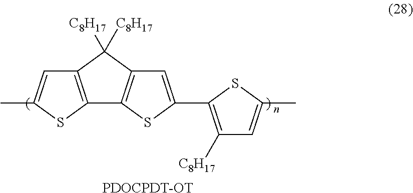

Comparing with the structure formula (1), it can be known that both R₁ and R₂ in the structure formula (1) are —C₈H₁₇, X is the structure formula (2), and both m and p are 1. Comparing with the structure formula (2), Y in structure formula (2) is S, R₃ is —H, and R₄ is —C₈H₁₇. In structure formula (28), n is 24.

The synthesis processes of the structure formula (28) are shown in Schemes 1A and 1B, wherein THF is tetrahydrofuran, DMF is dimethyl formamide, and EG is ethylene glycol.

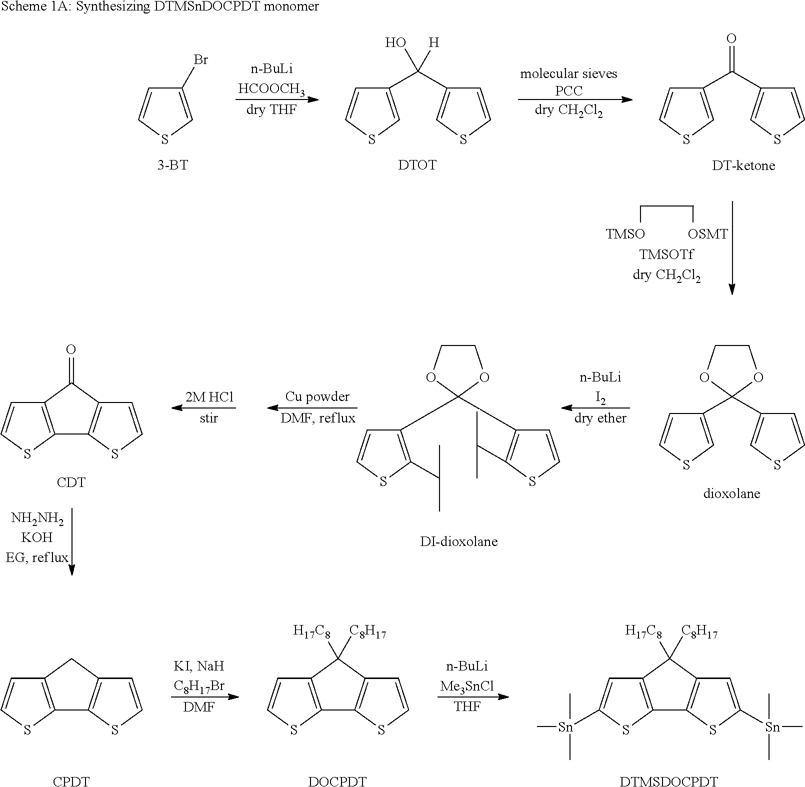

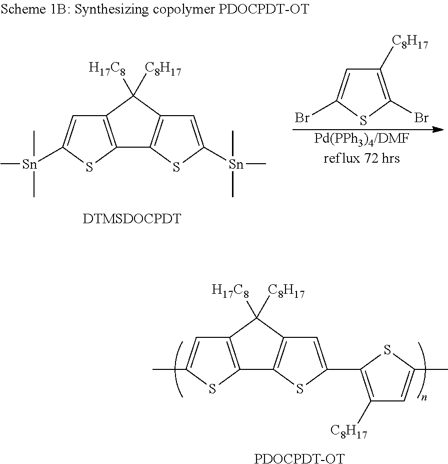

DTOH in Scheme 1A was synthesized as the following: A 1000 ml two-neck round-bottom flask was used to load 30 g 3-BT, wherein one neck of the flask was capped with a valve. A 300 ml of dry hexane was added to the flask, and argon was then supplied into the flask and then evacuated. The process of adding argon and then evacuated was repeated for three times to remove the moisture inside the flask. Then, the temperature was cooled down to −78° C., and 73.6 ml, 2.5 M n-BuLi and 30 ml dry THF were then sequentially added to the flask and the mixture was stirred for 15 minutes. Maintaining at −78° C., a mixed solution of 5.2 g HCOOCH₃ and 20 ml THF was dropwisely added into the flask in 10-15 minutes (as slow as possible) and then stirred for 3 hours. After the reaction mixture was back to the room temperature, 150 ml saturated NH₄Cl aqueous solution was added and then stirred for 30 minutes to terminate the reaction.

The product was extracted by ether for several times, the collected organic solution was then dried by MgSO₄, filtered and concentrated. An eluent mixed of hexane and ethylene acetate (EA) in a volume ratio of 25:1 and 240-400 mesh of a silica gel column were used to purify the product 16.45 g of DTOH was obtained, and the yield of DTOH was about 91%.

DT-ketone in Scheme 1 was synthesized as the following: A 500 ml round-bottom flask was used to load 16.45 g of DTOH and 250 ml dry CH₂Cl₂, and 10 g of ground molecular sieve were then added, wherein the ground molecular sieve was used to absorb water generated during the reaction. Another sample bottle was used to load 27.965 g of Pyridinium chlorochromate (PCC). PCC was added into the 500 ml round-bottom flask at 0° C. After the reaction mixture returns to room temperature and stirring for 10 hours, then 200 ml of dry ether was added.

Celite and silca in a weight ratio of 1:1 and ether were mixed in a 100 ml beaker. The Celite-silca-ether mixture was then poured into a Buchner funnel, and excess ether was then removed by filtration. The mixture in the 500 ml round-bottom flask above was then poured into the Celite-silca filled Buchner funnel and the filtrate was collected. The filtrate was then dried by MgSO₄, filtered and concentrated. An eluent contains hexane and ethylene acetate (EA) in a volume ratio of 50:1 and 240-400 mesh of a silica gel column were used to purify the product. 13.8 g of DT-ketone was obtained, and the yield of DT-ketone was about 85%.

Dioxolane in Scheme 1A was synthesized as the following: A 1000 ml side-armed round-bottom flask was used to load 13.8 g DT-ketone and 250 ml dry CH₂Cl₂, and argon was then filled and evacuated for three times. At 0° C., 30.22 g of 1,2-Bis-trimethylsilanyl-oxy-ethane was slowly added to the side-armed round-bottom flask and followed by adding 3.5 ml of catalyst, trimethylsilyltri-fluoromethanesulfonate. After returning to room temperature, the mixture was stirred for another 3 hours.

3 ml of dry pyridine was added to quench the reaction, followed by 250 ml saturated aqueous solution of NaHCO₃. The product was extracted with ether for several times, and the combined organic solution was dried by mixed Na₂CO₃ and Na₂SO₄ in a weight ratio of 1:1, filtered and then concentrated to remove organic solvent. An eluent contains hexane and ethylene acetate (EA) in a volume ratio of 50:1 and 240-400 mesh of a silica gel column were used to purify the product. 11.9 g of white solid dioxolane was obtained, and the yield of dioxolane is about 70%.

DI-dioxolane in Scheme 1A was synthesized as the following: A 250 ml side-armed round-bottom flask was used to load 11.9 g dioxolane and 125 ml dry ether. Another 500 ml side-armed round-bottom flask was used to load 25.81 g of I₂, and 10 ml of dry ether was then added to dissolve I₂. The DI-dioxolane solution was then transferred via a needle bridge to the side-armed round-bottom flask containing I₂. The mixture was stirred for 3 hours at room temperature and then 100 ml of pure water was added to terminate the reaction.

The organic layer was collected and sequentially washed by 40 ml of 30 wt % Na₂S₂O₃(aq) and 40 ml water to remove impurities therein and then dried by MgSO₄. After filtering, the filtrate was then concentrated to remove most organic solvent and dried in high vacuum to obtain DI-dioxolane.

CDT in Scheme 1A was synthesized as the following: In a 500 ml round-bottom flask containing the obtained DI-dioxolane, 9.5304 g Cu powder and 150 ml DMF were added and then refluxed for 15 hours. The reaction was terminated by stop heating. After back to room temperature, the reaction mixture was filtered under a reduced pressure and washed by a small amount of DMF and ether. The filtrate was collected and then 250 ml of 2 M HCl aqueous solution was added to the filtrate and stirred for 4-5 hours to perform the de-protection reaction. The product was extracted with ether for several times. The combined organic solution was sequentially washed by 2 M HCl aqueous solution, saturated NaHCO₃ aqueous solution, and pure water. The washed organic solution was then dried by MgSO₄, filtrated and then concentrated to remove organic solvent. An eluent contains hexane and ethylene acetate (EA) in a volume ratio of 50:1 and 240-400 mesh of a silica gel column were used to perform the purification. 5.8 g of CDT purple solid was obtained, and the yield of CDT is about 22%.

CPDT in Scheme 1A was synthesized as the following: A 250 ml two-neck round-bottom flask was used to load 5.8 g CDT and 100 ml ethylene glycol. After heating to 180° C. under nitrogen atmosphere, the color of the CDT solution turned to red. Then, 10.2 ml hydrazine hydrate was slowly injected into the red solution. The reaction mixture was then refluxed for 1 hour at about 180° C., and the color of the red solution turned to orange. 5.8 g of KOH was slowly added into the orange solution to avoid suddenly boiling, and the temperature was raised to 210° C., reflux for another 8 hours.

After cooling to room temperature, the reaction mixture was neutralized by 1.2 M HCl aqueous solution, and the product was extracted with ether. The extracted ether solution was sequentially washed by distilled water, saturated NaCl aqueous solution, and saturated NH₄Cl aqueous solution for three times, respectively. The washed ether solution was then dried by MgSO₄, filtered, and concentrated to remove organic solvent. Hexane and 200-400 mesh of a silica gel column were used to purify the product. 3.82 g of CPDT pale yellow solid was obtained, and the yield of CPDT is about 71%.

DOCPDT in Scheme 1A was synthesized as the following: 250 ml two-neck round-bottle flask was used to load 3.82 g CPDT and 25 ml DMF. 0.38 g of KI and 1.29 g of NaH were then added to the flask, and the mixture reacted for 2 hours under argon atmosphere at 0° C. Then 9.36 ml of C₈H₁₇Br was subsequently added and then reacted for another 8 hours. Distilled water was added to terminate the reaction, and the product was extracted with ether for several times. The extracted ether solution was sequentially washed by distilled water, saturated NaCl aqueous solution, and saturated NH₄Cl aqueous solution. The washed ether solution was then dried by MgSO₄, filtered, and concentrated to remove organic solvent. Hexane and a silica gel column were used to perform the purification to obtain 4.9 g of DOCPDT pale yellow oil. The yield of DOCPDT is about 57%.

DTMSnDOCPDT in Scheme 1A was synthesized as the following: 50 ml side-armed round-bottom flask was used to load 0.5 g DOCPDT and 20 ml dry THF. Then, argon was injected and evacuated for three times to remove the moisture inside the flask. 1.23 ml of 2.5 M n-BuLi was added at −78° C. and reacted for 2 hours when the mixture returned to room temperature. Next, 0.57 g Me₃SnCl in 4 ml dry THF was injected at −78° C. and reacted for 10 hours when the mixture returned to room temperature.

Distilled water was added to terminate the reaction and CH₂Cl₂ was used to extract the product. The extracted organic solution was sequentially washed by distilled water, saturated NaCl aqueous solution, and saturated NH₄Cl aqueous solution. The washed organic solution was then dried by MgSO₄, filtered, and concentrated to obtain DTMSnDOCPDT. ¹H-NMR chemical shifts (δ_{H}/ppm in CDCl₃, 300 MHz) of DTMSnDOCPDT are: 0.35 (18H, s), 0.84 (6H, t), 1.13 (24H, m), 1.81 (4H, m), and 6.91 (2H, s).

Next, the copolymerization reaction in Scheme 1B was performed to obtain PDOCPDT-OT. 0.63 g DTMSnDOCPDT, 0.30 g 2,5-dibromo-3-octylthiophene, and magnet were added in a 100 ml side-armed round-bottom flask, and 50 ml DMF was subsequently added. After well-mixing, the temperature of the mixture was cooled down to −78° C. to solidify the mixture and then evacuated. Argon was injected after the temperature back to room temperature and the reaction mixture melted. The actions of decreasing temperature, evacuating, increasing the temperature, and injecting argon were repeated for four times.

Very little amount of dry THF was used to dissolve 0.02 g of Pd(PPh₃)₄ catalyst. The catalyst solution was then injected under argon atmosphere into the flask. The reaction mixture was heated to 120° C. and refluxed for 3 days. The temperature of the reaction mixture was cooled down to room temperature and then filtered. 500 ml of methanol was added to the filtrate and stayed for the product to precipitate. The precipitate was collected by centrifugation. The collected precipitate was put in a cylindrical filter paper in a soxhlet extractor and then respectively washed by methanol, ethanol and acetone for several days. Finally, hexane was used to extract the product. The extracted hexane solution was concentrated to obtain PDOCPDT-OT red powder. ¹H NMR chemical shifts of PDOCPDT-OT (δ_{H}/ppm in CDCl₃, 200 MHz) are: 0.85 (6H), 1.17 (24H), 1.82 (4H), 2.78 (2H), and 7.01 (4H).

### Embodiment 2

In this embodiment, the synthesized conjugated polymer was shown in structure formula (29) below:

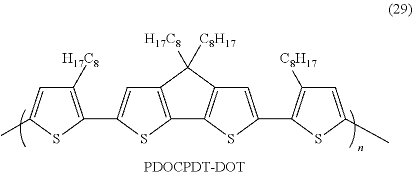

Comparing with structure formula (1), it can be known that both R₁ and R₂ in structure formula (1) are —C₈H₁₇, X is structure formula (2), m is 1, and p is 2. Comparing with structure formula (2), Y in structure formula (2) is S, R₃ is —H, and R₄ is —C₆H₁₇. In structure formula (29), n is 50.

The synthesis process of the structure formula (29) is shown in Schemes 2A-2C, wherein THF is tetrahydrofuran, DMF is dimethyl formamide, and EG is ethylene glycol.

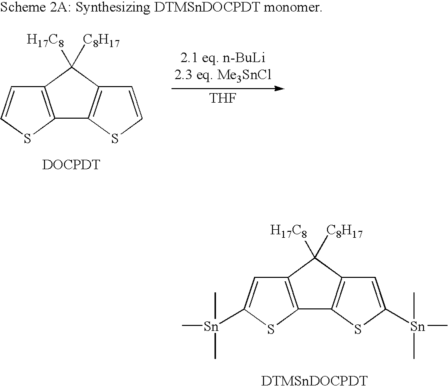

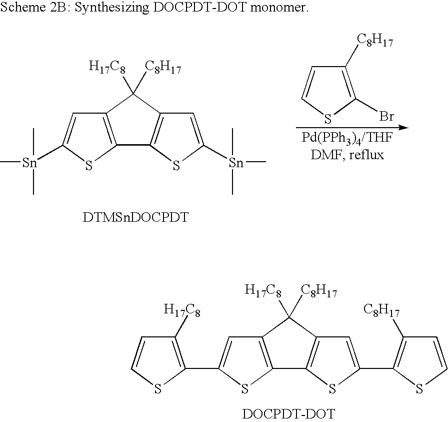

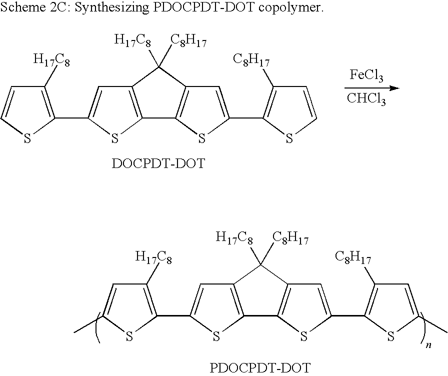

First, DTMSnDOCPDT in Scheme 2A was synthesized as the following: 50 ml of side-armed round-bottom flask was used to load 0.5 g DOCPDT which was prepared by the method shown in Scheme 1A. 20 ml of dry THF was added to dissolve DOCPDT. Next, the moisture inside was removed by injecting argon and evacuating for three times. 1.23 ml of 2.5 M n-BuLi was added at −78° C. and reacted for 2 hours at room temperature. Next, 0.57 g Me₃SnCl in 4 ml dry THF was injected at −78° C. and reacted for 10 hours at room temperature. Distilled water was added to terminate the reaction, and CH₂Cl₂ was used to extract the product. The extracted organic solution was sequentially washed by distilled water, saturated NaCl aqueous solution, and saturated NH₄Cl aqueous solution. The washed organic solution was then dried by MgSO₄, filtered, and concentrated to obtain DTMSnDOCPDT.

Afterwards, DOCPDT-DOT monomer in Scheme 28 was synthesized. 250 ml side-armed round-bottom flask was used to load 1.64 g DTMSnDOCPDT, 1.24 g 2-bromo-3-octylthiophene, a magnet and 40 ml dry DMF. The temperature of reaction mixture was cooled down to −78° C. then evacuated, and argon was then injected when the mixture returns to room temperature. The actions of cooling-evacuating-melting-filling gas were repeated for four times. Under argon atmosphere, 0.0522 g Pd(PPh₃)₄ catalyst in 20 ml THF was injected to the flask and then refluxed for 72 hours at about 150° C. After the temperature of the reaction mixture back to the room temperature, 50 ml of saturated NH₄Cl aqueous solution was added to terminate the reaction.

The reaction mixture was extracted with CH₂Cl₂. The extracted organic solution was then washed by de-ionized water for 6-7 times to remove DMF. The organic solution was dried by MgSO₄, filtered under a reduced pressure, and concentrated to remove organic solvent. Hexane and 200-400 mesh of a silica gel column were used to perform the purification. 0.58 g of DOCPDT-DOT orange liquid was obtained. The yield of the DOCPDT-DOT was about 65%. ¹H-NMR chemical shifts (δ_{H}/ppm in CDCl₃, 300 MHz) of DOCPDT-DOT are: 0.88 (6H, t), 1.2 (20H, m), 1.72 (4H, t), 1.82 (4H, t), 2.78 (4H, t), 6.93 (2H, d), 6.96 (2H, s), and 7.15 (2H, d).

Next, PDOCPDT-DOT copolymer in Scheme 2C was synthesized. 100 ml side-armed round-bottom flask was used to load 0.5787 g DOCPDT-DOT. A magnet and 0.83 g of FeCl₃ was then added into the flask. The flask was evacuated and then argon was injected, the evacuating—injecting argon was repeated for three times. Dry CHCl₃ was injected under argon, and the reaction mixture was stirred for 72 hours. Then, large amount of methanol was added to terminate the reaction. The reaction mixture was stayed for precipitation and then filtered to obtain the precipitate.

The precipitate was put in a cylindrical filter paper in a Soxhlet extractor and then respectively washed by methanol, ethanol and acetone to remove impurities. Then, hexane, CHCl₃ and THF were sequentially used to extract the precipitate. The extracted solution was concentrated and vacuumed to obtain PDOCPDT-DOT reddish black solid. ¹H-NMR chemical shifts (δ_{H}/ppm in CDCl₃, 300 MHz) of PDOCPDT-DOT are: 0.88 (6H, t), 1.2 (20H, m), 1.70 (4H, s), 1.84 (4H, s), 2.78 (4H, s), and 6.99 (4H, s).

### Measurement of Electrochromic Properties—Method 1

The methods for measuring the electrochromic properties of a material, including optical contrast, response time, and coloring efficiency are discussed below. The electrochromic properties of the exemplary conjugated polymer PDOCPDT-DOT described above is used to compare with the prior art conjugated polymer.

Electrochromism is the phenomenon displayed by some materials which reversibly change their UV-Vis absorption spectra when they gain or lose electron. Since the UV-Vis absorption spectra change, the colors of the materials also change. Conjugated polymers are materials shown electrochromism. Furthermore, conjugated polymers can switch between coloring status and bleaching status through the modification of chemical structures or control by the redox reactions occurred on the conjugated polymer.

The optical contrast, response time, and coloring efficiency of the conjugated polymers were measured by UV-Vis spectrometer (Cary 5E) and electrochemical potentiostat/galvanostat (AutoLab potentiostat/galvanostat, PGSTAT30). In the measuring system, the work electrode was ITO glass coated with a conjugated polymer film, the reference electrode was Ag/Ag⁺, and the counter electrode was Pt sheet. The electrolyte solution was 0.1 M LiClO₄/CH₃CN solution. The size of the ITO glass was 4 cm×4 cm, and the polymer coated area was 2 cm×1 cm.

The above conjugated polymer film underwent redox reactions accompanied by color change when the working electrode was applied by various electric potentials. The electrochemical potentiostat/galvanostat recorded the electric potential applying time and the redox current. The UV-Vis spectrometer simultaneously recorded the change of the absorption maximum. Then, optical contrast (Δ% T) and coloring efficiency (η) were calculated by formulas (1-1) and (1-2). The response time of an electrochromic material is defined as the time needed to reach 95% of the change in the optical contrast when an electrical potential was applied to the material.

Δ% T=T_{b}−T_{c} (1-1)

Δ% T: optical contrast

T_{b}: the transmittance of the bleaching status

T_{c}: the transmittance of the coloring status

η(cm²/C)=(ΔOD)/Q_{d}=log [T_{b}/T_{c}]/Q_{d} (1-2)

η: coloring efficiency

ΔOD=log [T_{b}/T_{c}]

Q_{d}: amount of the injected electron or hole per unit area (C/cm²)

The resulting electrochromic properties of PDOCPDT-DOT are shown in Table 1. In Table 1, electrochromic properties of other prior art conjugated polymer, such as PMeT, PHexT, and POcT (Pang, Y.; Li, X.; Ding, H.; Shi, G.; Jin, L. Electrochimica Acta. 2007, 52, 6172-6177) are also listed.

TABLE 1
the electrochromic properties of some conjugated polymers

| | red/ox^{a} | | | | | |
|---|---|---|---|---|---|---|
| Conjugated | potential | λmax | | | η | color |
| polymer | (V) | (nm) | Δ % T | τ(s)^{b} | (cm²/C) | (red/ox)^{a} |
| PDOCPDT- | 0.45/0.19 | 523 | 61/59 | 0.9 | 400 | Red/pale |
| DOT | | | | | | blue |
| PMeT | 0.83/0.43 | 500 | 46/44 | 1.1 | 250 | Bright red/ |
| | | | | | | bright blue |
| PHexT | 0.96/0.74 | 460 | 45/42 | 1.4 | 220 | Orange |
| | | | | | | red/blue |
| POcT | 0.95/0.78 | 440 | 39/33 | 1.9 | 230 | Orange |
| | | | | | | yellow/deep |
| | | | | | | blue |

^{a}Red represents the reduction status, and ox represents oxidation status.
^{b}τ(s) represents response time,

From Table 1, the electrochromic performance of PDOCPDT-DOT polymer of Embodiment 2 was better than the prior art polymer, since PDOCPDT-DOT has shorter response time, better coloring efficiency, and lower color switching potential.

Accordingly, since the conjugated polymers of the embodiments have the cyclopentadithiophenyl group as shown in the structure formula (30), the conjugated polymers of the embodiments have better electrochromic properties. Therefore, electrochromic devices having a shorter response time, higher optical contrast, and higher coloring efficiency can be obtained when the conjugated polymers of the embodiments are applied on the electrochromic devices.

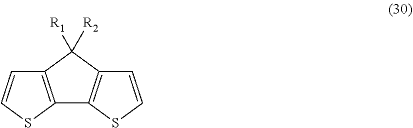

### Measurement of Electrochromic Properties—Method 2

Continuous potential switching was used to measure the electrochemical and optical stability of the conjugated polymers.

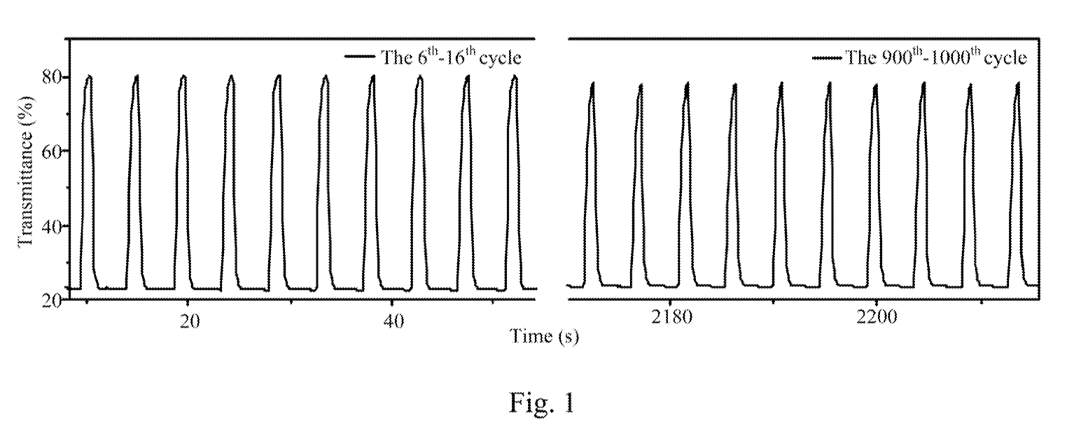

FIG. 1 is the variation of the transmittance of the absorption maximum for PDOCPDT-DOT film in Embodiment 2 during the 1000 redox cycles in a three-electrode system using PDOCPDT-DOT film coated ITO as a working electrode. In FIG. 1, there was no obvious variation of the transmittance for PDOCPDT-DOT film upon 1000 times redox switching. Therefore, PDOCPDT-DOT film had good electrochemical and optical stability that made PDOCPDT-DOT suitably to be applied on various electrochromic devices.

Accordingly, the conjugated polymers in the embodiments have the following advantages:

1. Since all of the conjugated polymers have the pentacyclodithiophenyl group shown in structure formula (30), the conjugated polymers have good processing property and high electrochemical stability.

2. Since all of the conjugated polymers are synthesized by copolymerization of pentacyclodithiophenyl group in structure formula (30) and the monomers shown in formulas (2)-(27), various colors including red, green, blue, and black can be provided by the conjugated polymers with various chemical structures.

3. The conjugated polymers have better coloring efficiency and lower color switching potential.

4. The conjugated polymers can be applied to the electrochromic devices and used as a photovoltatic material for the polymer solar cells.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A conjugated polymer, the structure formula of the conjugated polymer is shown as below: 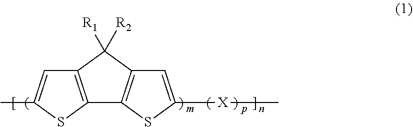
Wherein m is 1-4, p is 0-3, and n is 3-10000;
R₁ and R₂ is —H, —CₐH₂ₐ₊₁, —OCₐH₂ₐ₊₁, —SCₐH₂ₐ₊₁, —N(CₐH₂ₐ₊₁)₂ or —[O(CₐH₂ₐ)₂]_{b}, respectively, wherein a is 1-15, and b is 1-5; and
X is an unsaturated moiety.

2. The conjugated polymer of claim 1, wherein the chemical structure of the X is one of the following structure formula (2)-(27) as shown below: 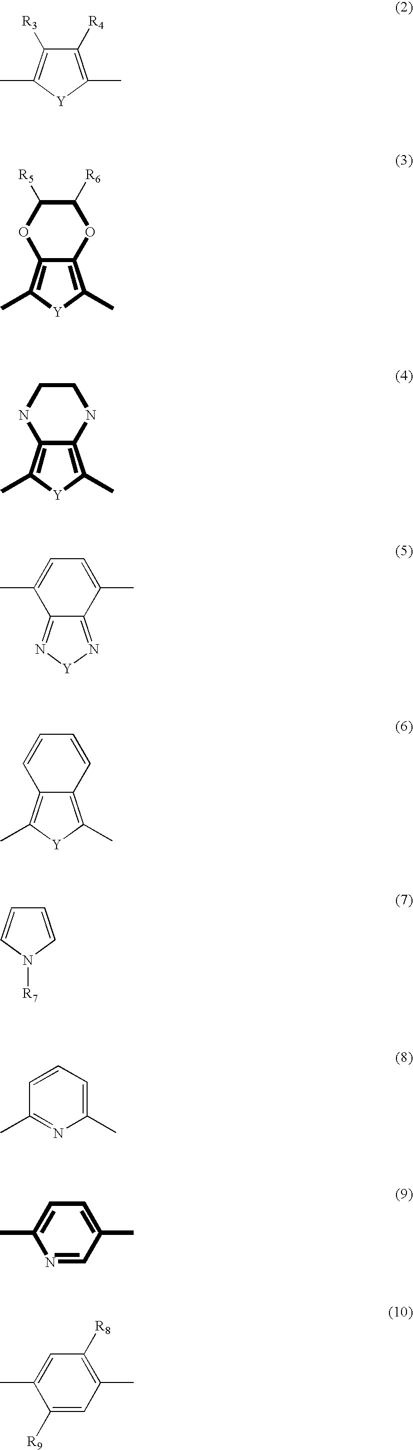 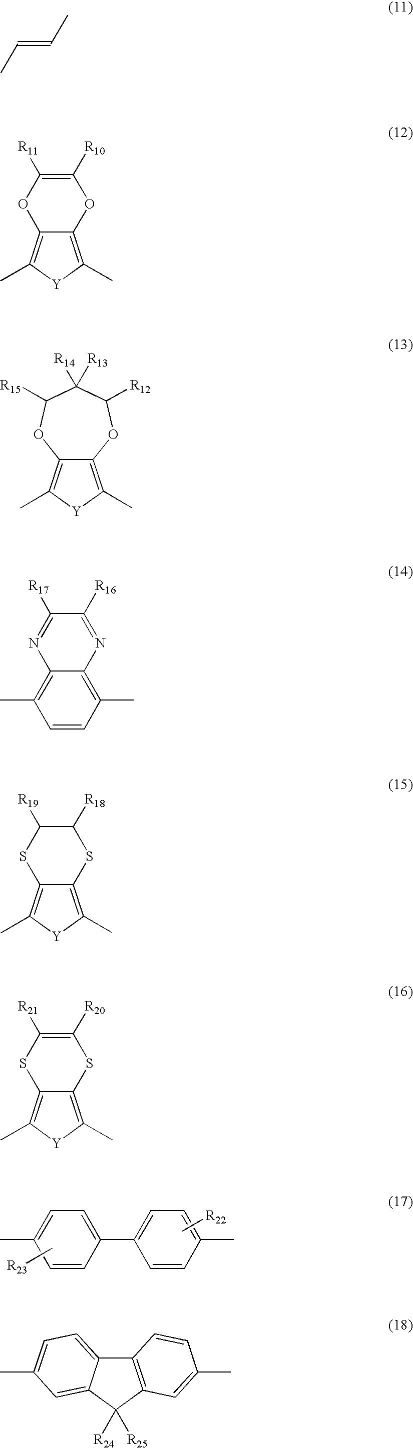 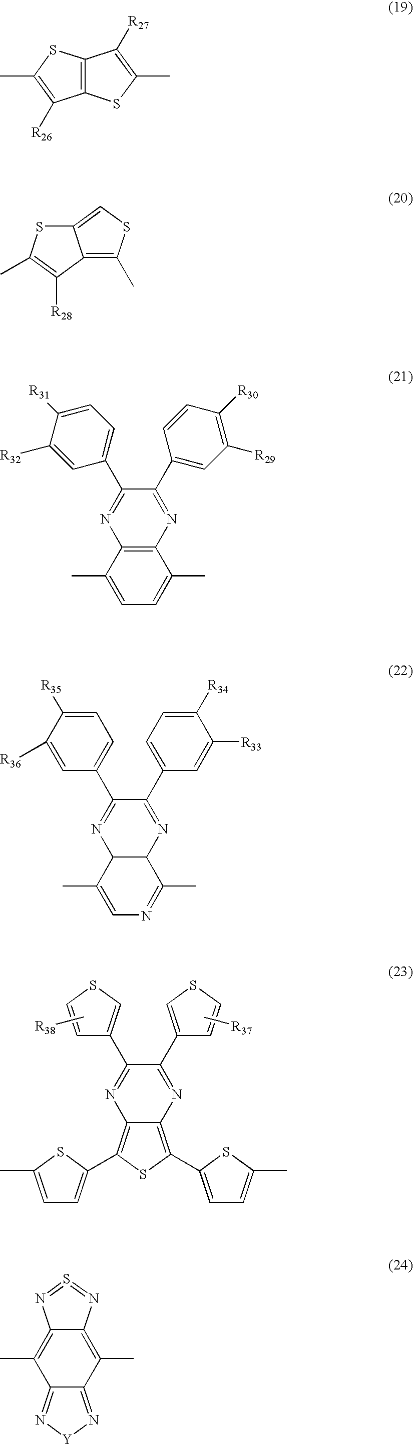 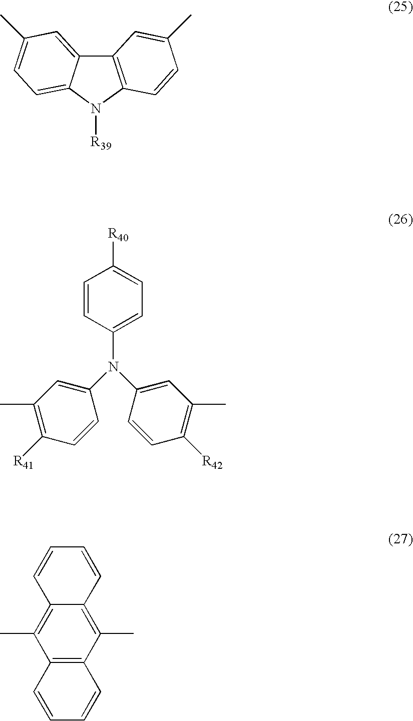
Wherein Y is O, S, or Se; and
R₃-R₄₂ is —H, —C_{c}H_{2c+1}, —OC_{c}H_{2c+1}, —SC_{c}H_{2c+1}, —N(C_{c}H_{2c+1})₂ or [O(C_{c}H_{2c})₂]_{d}, respectively, wherein c is 1-15, and d is 1-5.

3. The conjugated polymer of claim 2, wherein the structure formula of the conjugated polymer is shown as below:

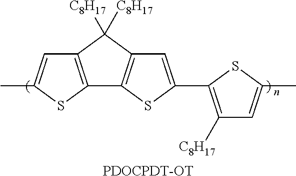

4. The conjugated polymer of claim 2, wherein the structure formula of the conjugated polymer is shown as below:

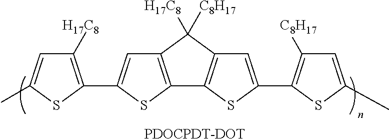

5. An electrochromic material, comprising a conjugated polymer having the structure formula shown as below: 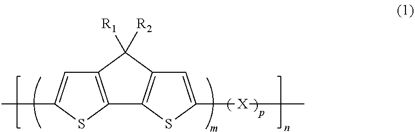
Wherein m is 1-4, p is 0-3, and n is 3-10000;
R₁ and R₂ is —H, —CₐH₂ₐ₊₁, —OCₐH₂ₐ₊₁, —SCₐH₂ₐ₊₁, —N(CₐH₂ₐ₊₁)₂ or —[O(CₐH₂ₐ)₂]_{b}, respectively, wherein a is 1-15, and b is 1-5; and
X is an unsaturated moiety.

6. The electrochromic material of claim 5, wherein the chemical structure of the X is one of the following structure formula (2)-(27) as shown below: 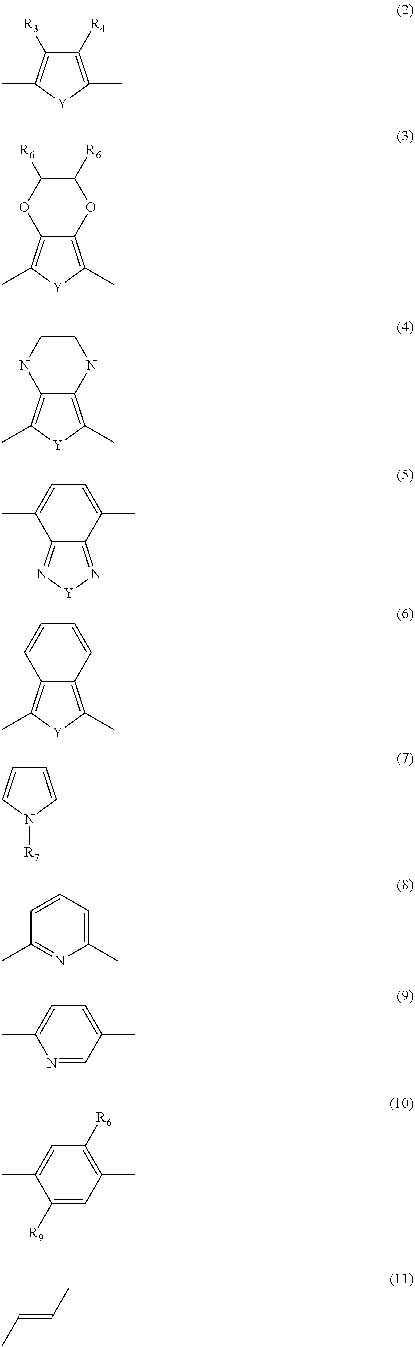 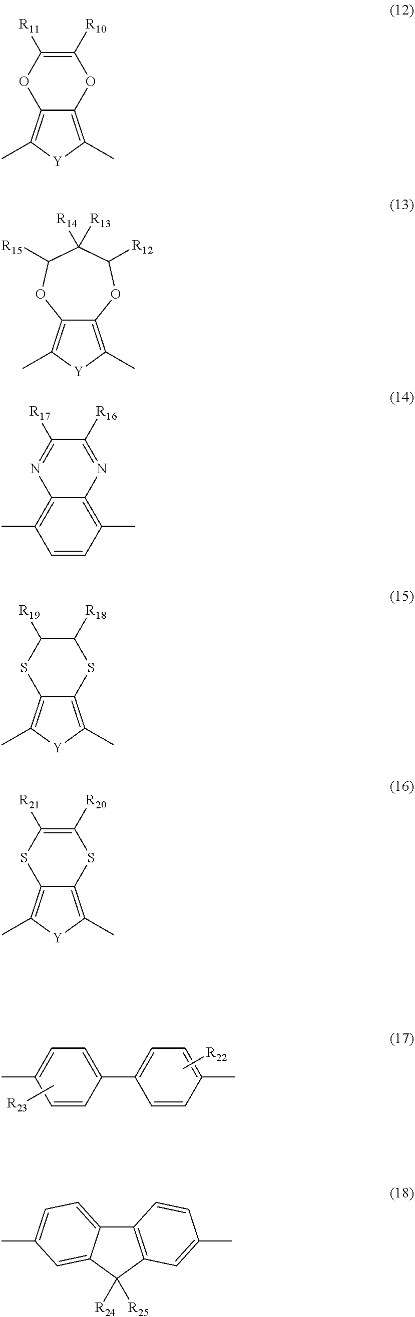 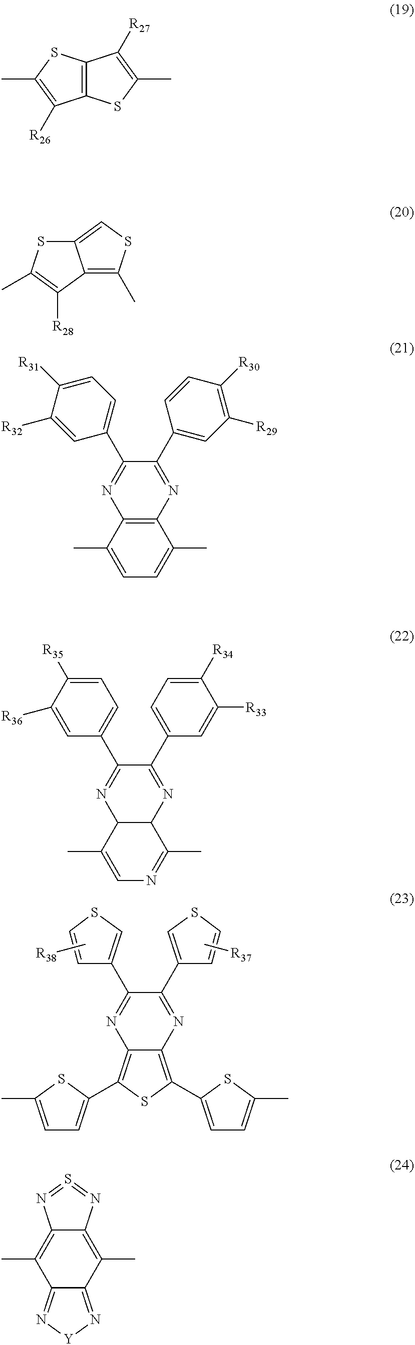 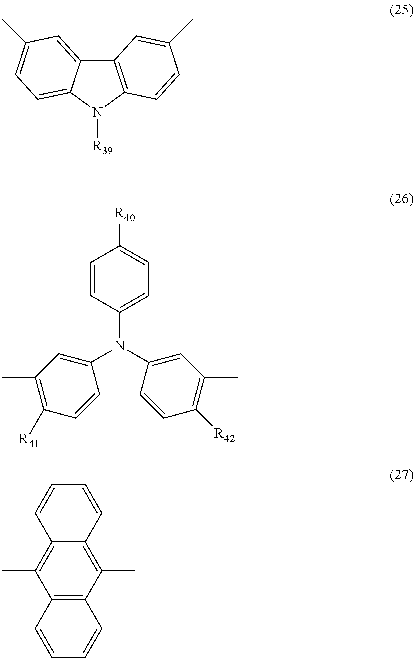
Wherein Y is O, S, or Se; and
R₃-R₄₂ is —H, —C_{c}H_{2c+1}, —OC_{c}H_{2c+1}, —SC_{c}H_{2c+1}, —N(C_{c}H_{2c+1})₂ or [O(C_{c}H_{2c})₂]_{d}, respectively, wherein c is 1-15, and d is 1-5.

7. The electrochromic material of claim 6, wherein the structure formula of the conjugated polymer is as shown below:

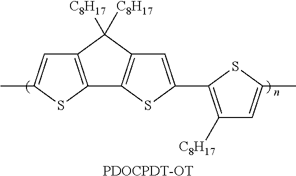

8. The electrochromic material of claim 6, wherein the structure formula of the conjugated polymer is as shown below:

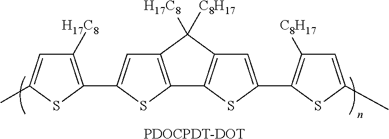

9. A photovoltatic material for polymer solar cells, the photovoltatic material comprising a conjugated polymer having the structure formula shown as below: 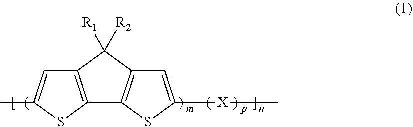
Wherein m is 1-4, p is 0-3, and n is 3-10000;
R₁ and R₂ is —H, —CₐH₂ₐ₊₁, —OCₐH₂ₐ₊₁, —SCₐH₂ₐ₊₁, —N(CₐH₂ₐ₊₁)₂ or —[O(CₐH₂ₐ)₂]_{b}, respectively, wherein a is 1-15, and b is 1-5; and
X is an unsaturated moiety.

10. The photovoltatic material of claim 9, wherein the chemical structure of the X is one of the following structure formula (2)-(27) as shown below: 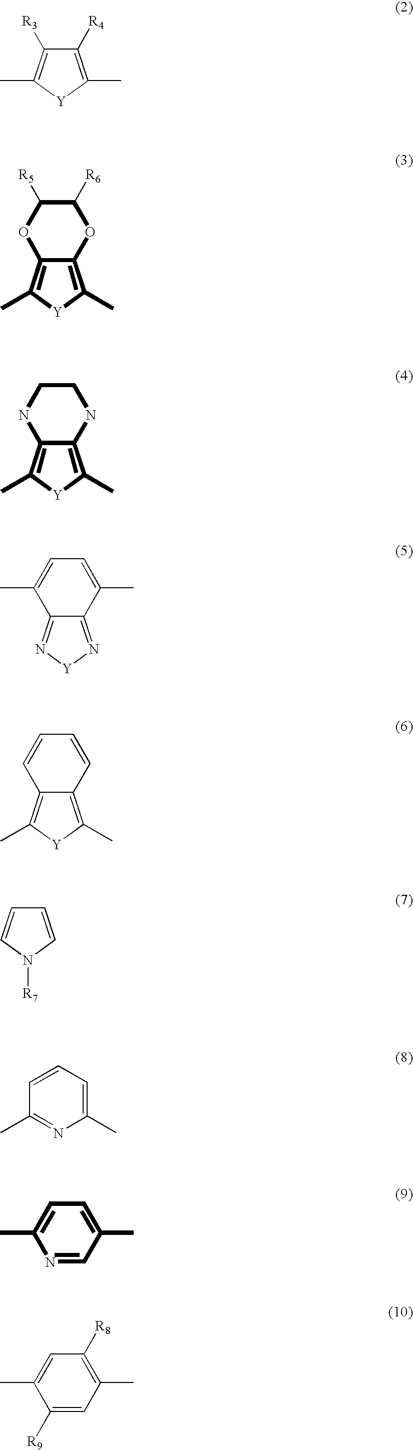 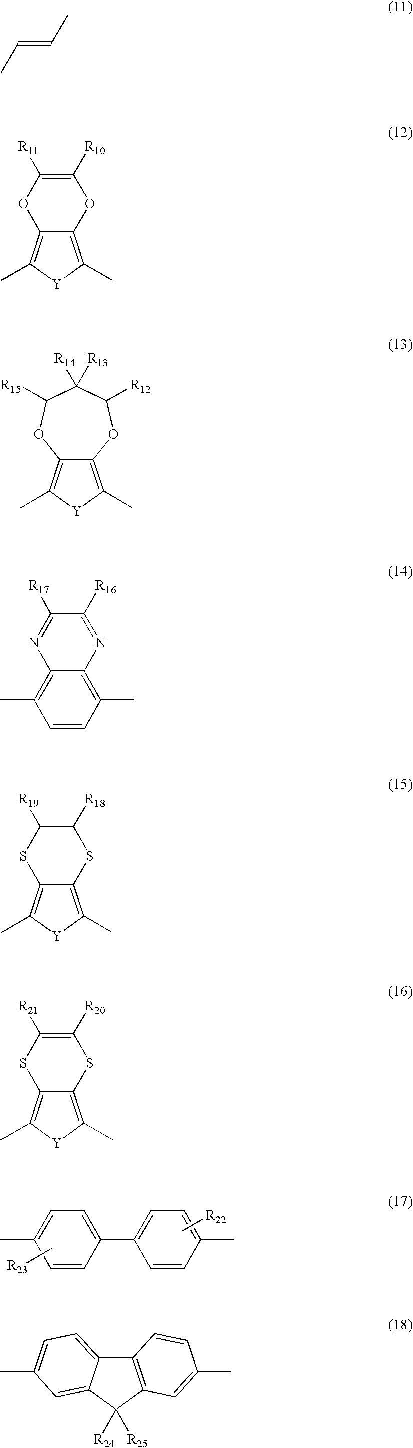 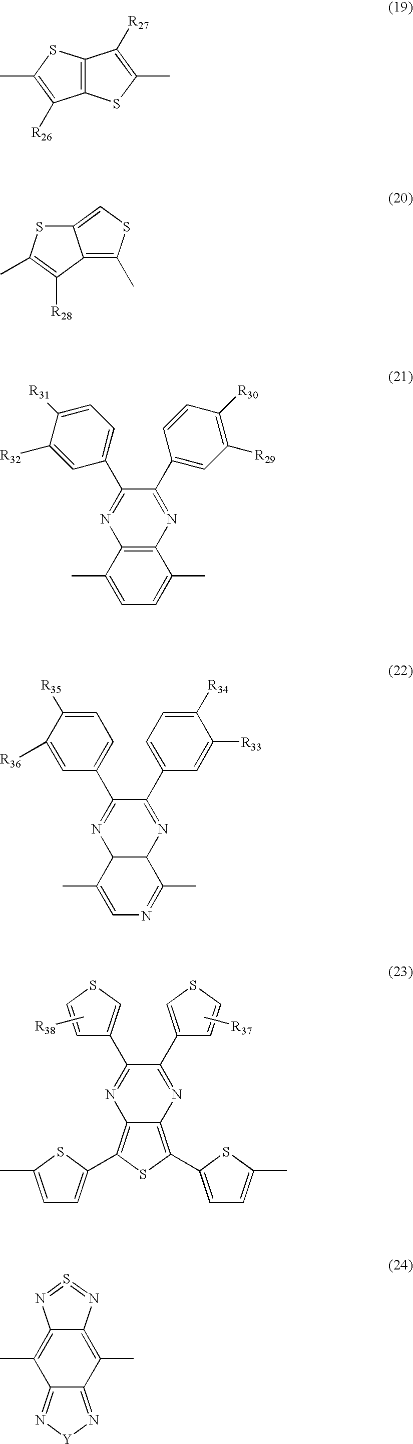 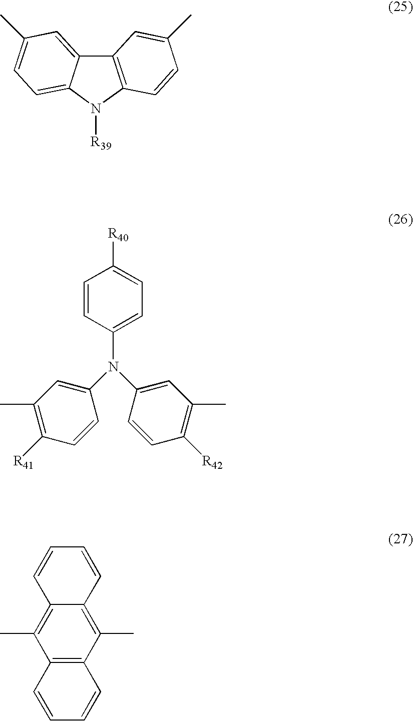
Wherein Y is O, S, or Se; and
R₃-R₄₂ is —H, —C_{c}H_{2c+1}, —OC_{c}H_{2c+1}, —SC_{c}H_{2c+1}, —N(C_{c}H_{2c+1})₂ or [O(C_{c}H_{2c})₂]_{d}, respectively, wherein c is 1-15, and d is 1-5.

11. The photovoltatic material of claim 10, wherein the structure formula of the conjugated polymer is shown as below:

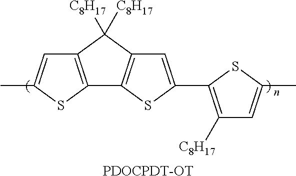

12. The photovoltatic material of claim 10, wherein the structure formula of the conjugated polymer is shown as below: [chemical structure]
